(19) United States
(12) Patent Application Publication
(10) Pub. No.: US 2004/0199664 A1
(43) Pub. Date: Oct. 7, 2004

(54) Method and system for improving a route along which data is sent using an ip protocol in a data communications network

(76) Inventors: Mordecai Feldman, Newe Efraim Monoson (IL); Sergei Ivanov, Newton, MA (US); Mark Shvartser, Modiin (IL); Ilya Yulish, Lod (IL)

Correspondence Address: BROWDY AND NEIMARK, P.L.L.C., 624 NINTH STREET, NW, SUITE 300, WASHINGTON, DC, 20001-5303, US

(21) Appl. No.: 10/482,665

(22) PCT Filed: Jul. 4, 2002
(86) PCT No.: PCT/IL02/00546

(30) Foreign Application Priority Data
Jul. 4, 2001 (IL) 144141

(51) Int. Cl. G06F 15/173

(52) U.S. Cl. 709/238

(57) ABSTRACT

A method and system for improving a route between a source node (24) and a target node (25) between which data is sent using an IP protocol in a data communications network (20) having a plurality of interconnected nodes (22) defining a plurality of possible routes (23) between the source node and the target node. For all available nodes in at least a portion of the network spanning the source node and the target node, a respective IP address and status is obtained dynamically together with their respective intercon-nections if viable. An improved route between the source node and a route node connected to the target node is determined dynamically and corresponding IP addresses are identified of improved route nodes spanning the improved route. The IP addresses are dynamically conveyed to the source node for allowing the source node to embed at least some of the IP addresses in the data so as to allow successive ones of the improved route nodes to which the data is routed to route the data to an adjacent one of the improved route nodes. This may be done by using the loose source routing feature supported by the IP protocol.

### FIELD OF THE INVENTION

This invention relates to route optimization in a data communications network, particularly the Internet.

### BACKGROUND OF THE INVENTION

The Internet is a vast communication network having thousands of nodes constituted by network servers allowing connection between any two points and in particular, a web site and a user surfing the net via almost limitless combinations of routes. The need to find some way to optimize the route between a surfer and the destination web site is recognized in the art and various solutions have been proposed.

On the Internet and in other networks, Quality of Service (QoS) is the idea that transmission rates, error rates, and other characteristics can be measured, improved, and, to some extent, guaranteed in advance. QoS is of particular concern for the continuous transmission of high-bandwidth video and multimedia information and other applications that have high bandwidth and high quality' concerns.

Transmitting this kind of content in a reliable fashion is difficult in public networks using ordinary “best effort” protocols.

Data packets are delivered from a source, typically at the content provider's web site, through an Internet path, to a target, typically a client machine of the end user. Each of these media affects the QoS. At the source point, an overloaded web site will induce delays in processing the request and sending out the information;

along the data path, congested links, Network Access Points (NAPs), Internet eXchanges (IXs) or routers will slow down delivery speed or even loose data. QoS is also affected by the content location. By pre-delivering the content as close as possible to the end destination, thereby creating a shorter path, less data traffic jams can be expected.

Various solutions to enhance QoS have entered the Internet market place over the past few years. These solutions can be categorized based on their type.

A cache server is a server relatively close to Internet users and typically within a common enterprise that saves (caches) Web pages and other files that all users have requested so that subsequent requests for these pages or files can be satisfied by the cache server rather than requiring the re-fetching of the information via the Internet A cache server not only serves its users by getting information more quickly but also reduces Internet traffic. Some cache servers, also imown as proxy servers, pre-fetch the content based on various algorithms so as to further speed-up the local viewing of the content.

FIG. 1 shows a prior art network 10 including a “Traffic Server” manufactured by Inktomi Corporation that operates as a cache server for enhancing Internet performance. The system 10 comprises a plurality of web servers operated by content providers such as HTTP server 11, streaming media server 12, NNTP server 13 and FTP server 14 all connected via the Internet 15 to a plurality of client machines 16 connected to the Internet via a Traffic Server 17 connected to a POP or local office 18. At the core of Inktomi's Traffic Server 17 is a highly scalable, high perfonmance cache server which stores frequently requested information at the edges of the network 10. By caching information locally, the Traffic Server 17 minimizes the amount of “upstream” bandwidth required to service customer requests for information. This reduces both the amount of traffic on the network as well as the time it takes end-users to retrieve information.

It is evidently clear that the effectiveness and profitability of this solution depends on the number of Traffic Servers distributed. It is further apparent that Inlctomi provides no path optimization within the Internet cloud 15; nor do other caching solutions providers provide path optimization.

Another known approach to enhancing network performance is used in a content delivery network. A content delivery network consists of many mirror sites, which are basically a Web site or set of files that has been copied to another computer server in order to reduce network traffic and to ensure better availability of the Web site or files. Mirroring is the practice of creating and maintaining mirror sites. A mirror site is an exact replica of the original site and is usually updated frequently to ensure that it reflects the content of the original site. Mirror sites are used to make access faster when the original site may be geographically distant to its end users or when the original site may not have a high-speed connection to the Internet.

A content delivery network improves the rate at which content is transmitted from the source to the target by shifting content from “slower” content source servers and distributing it among a grid of servers located closer to the end-users. It requires that a massive volume of data is moved through the Internet, to constantly update these servers. None of this obviates the need also to optimize the route from the content delivery network server to the end-user.

According to yet another approach, load balancing may be used to divide the amount of work that a computer has to do between two or more computers so that more work gets done in the same amount of time and, in general, all online users get served faster. Companies whose Web sites get a great deal of traffic usually use some form of load balancing. In some approaches, the servers are distributed over different geographic locations. Load balancing tools are located between the network and server farm, and continuously monitor each server and/or network device to ensure availability and performance, and route incoming queries to the most available server. These tools actually deal with data source points.

Another approach is the use of policy based networldng which manages a network's bandwidth so that various kinds of traffic receive the necessary bandwidth priority needed to serve the network's users effectively. With the convergence of data, telephone, and video traffic in the same network, companies will be challenged to manage traffic so that one kind of service does not preempt another kind. Using policy statements, network administrators can specify which kinds of service to give priority and at what times of day. This kind of policy-based management is a specific implementation of the Quality of Service concept.

Policy based networking requires allocation of network resources based on administratively defined policy rules at a specific router in the network, and possibly the enforcement of QoS rules on each network device. It is obvious that it is impossible for the policy administrator to derive such rules that would optimize the complete network performance. Routing decisions are taken locally by each network device, and are typically implemented via a number of Cisco/Juniper specific commands.

Policy based routing alters the normal amount of bandwidth available for a specific application on a per link basis. It does not utilize the individual links policies to generate an optimal path between the content service provider and the end user.

U.S. Pat. No. 6,009,081 in the name of InterNAP Network Services, published Dec. 28, 1999 discloses a method for interconnecting P-NAP customers with P-NAP providers and symmetrically routing packets between a P-NAP customer and a destination within a P-NAP provider's backbone across the P-NAP and that provider's backbone or symmetrically routing packets between a P-NAP customer and a destination not currently within a P-NAP provider's backbone across the P-NAP and a pre-defined P-NAP provider's backbone known as the default backbone. The method comprises creating a list of all P-NAP provider AS numbers and a list of all AS numbers which peer at public NAPs but which are not associated with P-NAP providers. For each P-NAP provider, take the union of all provider AS numbers and AS numbers associated with public NAPs and subtracting out AS numbers associated with the current provider. Deny that resulting list of AS numbers on routes as they are received from the current provider to approximate the routes which are deemed to be destined within the current provider's network by tagging these routes with the primary local preference value. For all routes that were denied, the secondary local preference value is attached. Set P-NAP provider local preferences causing the P-NAP provider to select direct routing from the P-NAP provider to the P-NAP. Make changes to AS path lengths of routes advertised by the P-NAP to each P-NAP provider to cause providers not directly connected to the P-NAP to use the same pre-selected P-NAP provider as the P-NAP uses to send to the providers.

According to the solution disclosed in U.S. Pat. No. 6,009,081, Internet data is delivered more quickly and reliably from point to point, bypassing possible Internet bottlenecks. This solution depends on the existence of a specialized series of private Network Access Points (NAPs) that maintain fast connectivity to major Internet Service Providers and requires the costly creation of an infrastructure of POPs/NAPs. In general, routing decisions are made based on local information learnt at the local POP. InterNAP's solution is known as the P-NAP (Private Network Access Point). The P-NAP sends customer data out via the fastest available Internet backbone to which it is connected, right at the P-NAP, rather than at a randomly chosen public NAP or private peering point like other Internet service providers.

Opnix Inc. builds its network in a similar fashion to InterNap but adds one additional factor. They monitor the entire global network and build a database of data paths. Their routing decision is not merely based on the fastest “near” connection, but rather on which path leads to a faster end-to-end solution. Their Orbit 1000 product actively gathers performance metrics (including packet loss, latency, exchange point congestion, layer-3 hops, AS hops, circuit congestion, and path reachability) across all carrier routes through all customer paths to determine which routes actually perform better. In such an approach, a plurality of computers are connected each to different nodes in the network and each for determining an optimal path for sending data from a source node connected thereto to a remote target node. Thus, each computer is responsible for optimizing the data path for all nodes under its aegis. This requires a large number of independent computers all working in parallel and thus introducing a lot of redundancy since, theoretically at least, each computer addresses the complete network. Moreover, each computer must be directly coupled to a node in the network from which data is to be sent along the optimal route to a remote target node. The data may be sent via such a computer so that the computer serves as both the vehicle for data communication and for route optimization. Thus, in such a system, the improved route nodes must be determined at the source node from which data is to be transmitted.

U.S. Pat. No. 6,205,121 in the name of Alcatel, published Mar. 20, 2001 discloses a method of establishing logical connections in a synchronous communications network comprising a plurality of at least partially interconnected network elements and designed for the transmission of data packets containing a destination address involves monitoring destination addresses of the data packets to be transmitted, determining the traffic volume between the individual network elements with the aid of the destination addresses, and determining an optimized configuration of logical connections based on the traffic volume and existing logical connections. In this manner, the communications network is adapted to the current traffic situation, and the transmission capacities of the network are utilized in the best possible manner. The monitoring is advantageously done in at least part of the network elements, while the determination of the traffic volume and the optimized configuration is performed by a central management system.

U.S. Pat. No. 5,606,669 published Feb. 27, 1997 and assigned to International Business Machines Corporation discloses a system for managing topology of a network in spanning tree data structure by maintaining link table and parent table in each network node. The system includes a topology manager within a data communication network including a number of nodes interconnected by bi-directional links, wherein each said node is provided with means for dynamically setting and storing within the node a full topology database including full parent-node-relationship references. The system is capable of fast path determination and fast spanning tree recovery based on the topology database contents.

U.S. Pat. No. 4,905,233 published Feb. 27, 1990 and assigned to Harris Corporation discloses a multiple path routing mechanism for packet communications network. The mechanism allows at least one transmission route to be established between a source node and a destination node in a multi-node communications network comprises monitoring transmission characteristics of each of the transmission paths among the respective nodes of the network so as to derive a plurality of path metrics representative of the ability of the respective transmission paths of the network to transmit communication signals. Then, feasible transmission routes to be used f6r the transmission of communication signals from the source node to the destination node are selected as those routes which extend from the source node to the destination node and each of which is comprised of one or more transmission paths among the nodes of the network and the sum of path metrics of transmission paths from neighboring nodes to the destination node is less than the path metric of a transmission path the end nodes of which correspond to the source and destination nodes. Communication signals are then transmitted from the source node to the destination node over the selected feasible trasmission routes.

### SUMMARY OF THE INVENTION

It is an object of the invention to provide an improved method and system for path optimization in a data communications network, such as the Internet, wherein data is sent using an IP protocol.

To this end, there is provided in accordance with a first aspect of the invention a method for conveying data along an improved route from a source node to a target node between which data is sent using an IP protocol in a data communications network having a plurality of interconnected nodes defining a plurality of possible routes between the source node and the target node, said method comprising:

(a) obtaining corresponding IP addresses of improved route nodes spanning said improved route, and

(b) embedding at least some of said IP addresses in said data so as to allow successive ones of said improved route nodes whose IP addresses are embedded in the data and which receive the data to route the data to an adjacent one of the improved route nodes thus allowing the improved route nodes to be determined remote from the source node.

According to one embodiment of the invention, the improved route nodes are received from a routing server coupled to the source node.

The invention uses optmization tools and standard features of the Internet protocol to dynamically derive best paths between any two points on the net. Within the context of the description and appended claims, the terms “improved” or “optimal” path relates to a path between two or more nodes in the network via which data is sent from a source node to a target node based on instantaneous network performance. It cannot always be ensured that in absolute terms, there is no better path particularly since the optimal path is apt to change dynamically owing to instantaneous loading and availability. However, by mapping the Internet to obtain the network layout, monitoring the dynamic status of the network components to derive their status at present time, and using optimization tools to calculate best path for data transfer, the invention achieves a better route that would be achieved using standard methods. Data packets are then transferred through the selected path, from source node to the target node.

The system comprises at least one main server, located at one principal site. Although the following description will describe a single server, it will be understood that in practice each provider may install a proprietary server, thus allowing each provider to optmize traffic flow between nodes in the network. The server maps, monitors and forecasts the network traffic load, or obtains the information from external sources. Given this data, an optimization module in the server or coupled thereto, generates the best paths. The server communicates with a software agent (client) installed on the Information source site (Content Provider). The agent receives a list of optimal paths from the server. When a packet is about to be sent, the agent attaches the proper path to it and sends it out via source routing or loose source routing. If desired, a sub-server may be installed dedicated for specific applications that require customized optimization. Such a sub-server receives the mapping data and monitored data from the main server, and runs the tailored optimization module.

Furthermore, although a preferred embodinent of the invention is described with reference to a central routing server that monitors the complete network or a part thereof, the invention may also be used with a Virtual Private Network where a source node itself routes the data to a target node, thus serving as its own routing server. To this extent, it will thus be understood that within the context of the invention and the appended claims the term “routing server” may be understood as both a physical device and as a logical device. In the case of a Virtual Private Network, the routing server may thus be a logical device that is embedded in the source node or is integral therewith or is otherwise associated therewith such that the source node is itself able to determine to which target node optimally to route the data. Moreover, in a Virtual Private Network, the destination node may obtain the information on the optimal route between source and destination from the routing server and send the request to source already containing this route.

Likewise, within the context of the invention and the appended claims the term “route” may be understood as both a physical route and as a logical route. Thus, for example, it may be required to map and monitor not all the Internet, but only those routers that support loose source routing to improve routes. This requirement can be met by means of an independent mapping unit that investigates the network with loose-source-routed pings and finds these “good routers”. Only 20 these routers and virtual (logic) connection between them are then monitored.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a block diagram of a prior art system directed to improving data rates in the Internet;

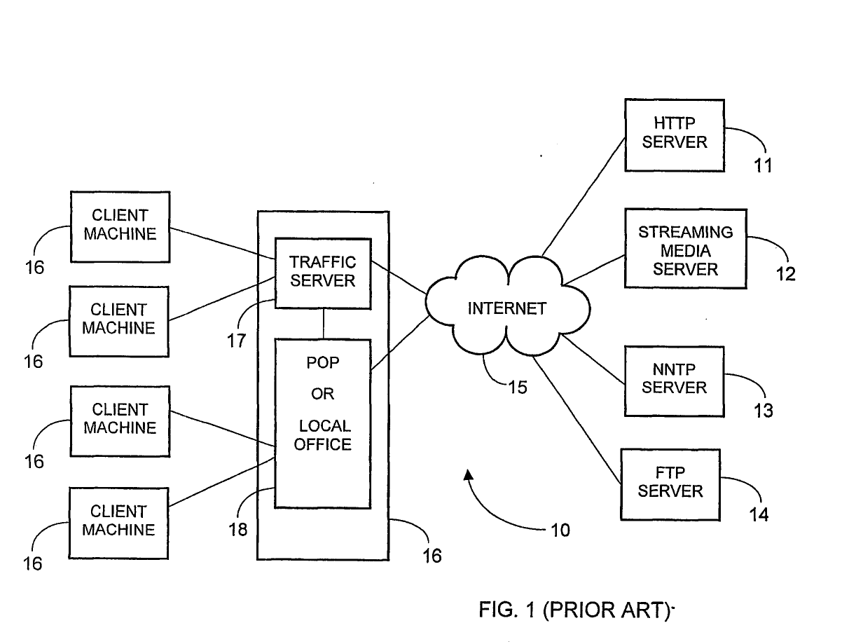

FIG. 2 is a schematic representation of a data communications network according to the invention;

FIG. 3 shows schematically how the network of FIG. 2 may be represented as a plurality of interconnected sub-networks for the purpose of routing data;

FIG. 4 is a block diagram showing a detail of a main routing server used in the network of FIG. 2;

FIG. 5 is a block diagram showing a detail of a content provider computer used in the network of FIG. 2;

FIG. 6 is a flow diagram showing the principal operations carried out by the main routing server; and

FIG. 7 is a flow diagram showing the principal operations carried out by a software agent in the content provider computer.

### DETAILED DESCRIPTION OF SPECIFIC EMBODIMENTS

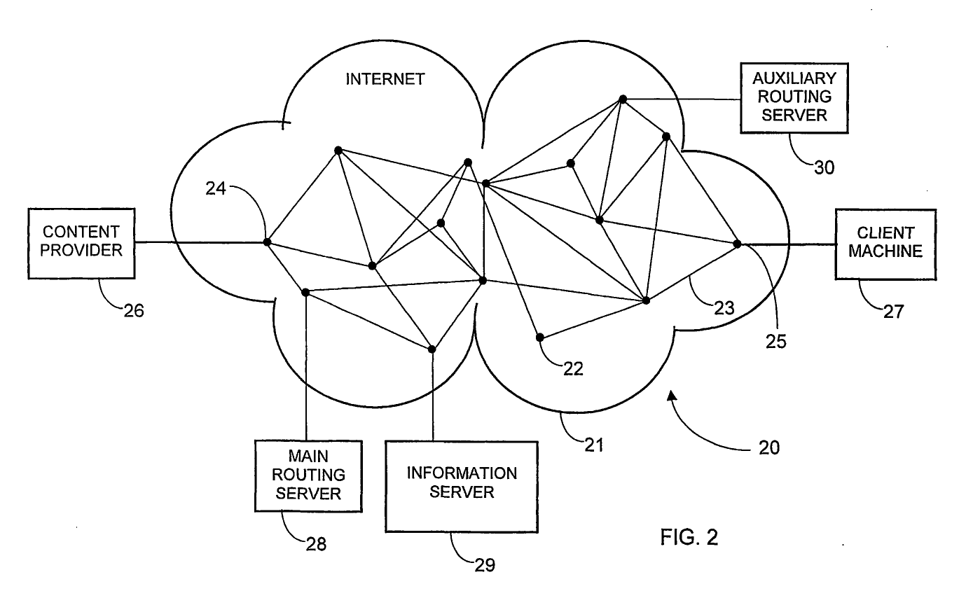

FIG. 2 shows schematically a data communications network depicted generally as 20 based on the Internet 21, although it may include an intranet or other networlc In either case, the network comprises a plurality of nodes 22 interconnected by paths 23 so that an arbitrary source node 24 may be connected to an arbitrary target node 25 via any one of multiple paths 23. Thus, the interconnected nodes 22 define a plurality of possible routes between the source node 24 and the target node 25. A content provider server 26 is coupled to the source node 24 for providing content to a client machine 27 coupled to the target node 25. In such a system any point on the network can thus be routed to any other point, at any time.

It is thus apparent that content (data) can flow from the source node 24 to the target node 25 via multiple routes. In order to optimize the selected route, a main routing server 28 and an information server 29 are coupled to the Internet 21 via respective nodes. Optionally, an auxiliary routing server 30 may be connected to the Internet 21. In fact, each of the servers 28, 29 and 30 may be constituted by multiple computers connected to the Internet 21 at different locations and adapted to operate in unison.

Each of the nodes has a unique IP address comprising a series of four numbers each between 0 and 255, separated by periods such as 212.150.153.194. Normally data is routed between different nodes of the network fairly randomly, often according to ad hoc rules determined by the content provider server 26 in accordance with the geographic location of the target node 25. The content provider server 26 decides to which node in the network to send the data, and the receiving node likewise decides to which subsequent node the data is to be routed. Eventually the target node 25 receives the data and directs it to the client machine 27.

However, the IP protocol by means of which data is routed through the network does malce provision for data to be routed to a limited number of pre-defined nodes. In this case, there may be embedded within the data the respective IP addresses of these nodes so that data may be routed from one node to the other without the receiving node having any discretion as to which subsequent node the data is to be routed. This feature of the IP protocol is called “source routing”. Currently, the source routing feature of the IP protocol is limited to the inclusion within the data string of only eight IP addresses. This allows the data to be routed from the source node to the target node via eight pre-defined routes spanning nodes whose IP addresses are embedded in the data string. However, in the event that data is to be routed via more than eight nodes, source routing is not feasible. Moreover, if any of the nodes whose IP address is thus embedded in the data string is not viable or if the route spanning any two such nodes is unavailable, the data packet will simply be discarded and the target node will never receive it.

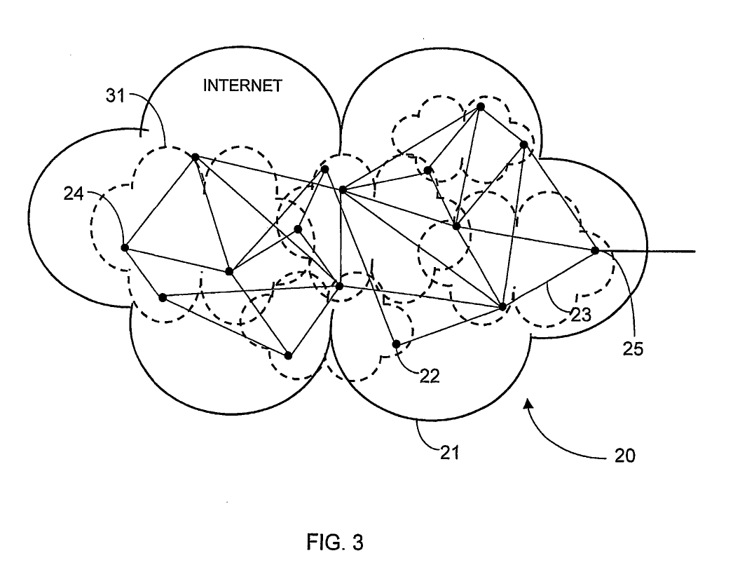

FIG. 3 shows schematically how the network of FIG. 2 may be represented as a plurality of interconnected sub-networlcs for the purpose of so-called “loose source routing” of data. The Internet 21 depicted by the conventional cloud is shown to comprise a plurality of sub-networks 31 also depicted by clouds and containing different nodes 22. Loose source routing allows the identity of the sub-networics 31 to be pre-defined in order that the data packets may be routed between specified sub-networks 31 rather than actual specific nodes 22. When loose source routing is used to route the data between successive nodes, a receive node is not restricted as to which subsequent node the data packet is to be sent Thus, in effect, each sub-network 31 allows data to be internally routed without restriction so long as the effective target node within the sub-network is the IP address of the effective source node of the next sub-network By such means, once a data packet is routed to a specified sub-network, it is directed to the next subnetwork 31 whose identity is embedded in the data packet until eventually it reaches the target node 25.

However, unlike source routing where the respective IP address of each successive node must be embedded in the data packet, in loose source routing each sub-network 31 is free to route the data via any of the nodes in that sub-network 31 to the next sub-network. The advantage of loose source routing is that data may be loosely routed along a predetermined route defmed by up to eight sub-networks 31.

The disadvantage is that since the data packet is not optimally routed within each sub-network 31, the overall route via which the data is routed between the source node 24 and the target node 25 is also not optimized. However, in practice the improvement achieved by loose source routing may be dramatic. Moreover, there may be occasions when data can be optimally routed between the source node 24 and the target node 25 via only eight nodes; and in this case regular source routing may be employed. Likewise, it will be appreciated that the limitation of up to only eight IP addresses arises from the current standard of the IP protocol and this may be extended in the future to allow the full benefits of source routing to be enjoyed between more than eight nodes.

The invention exploits source routing or loose source routing to embed within the data packet IP addresses that define an improved route that may or may not be optimal, but is better than would otherwise likely be selected using conventional techniques.

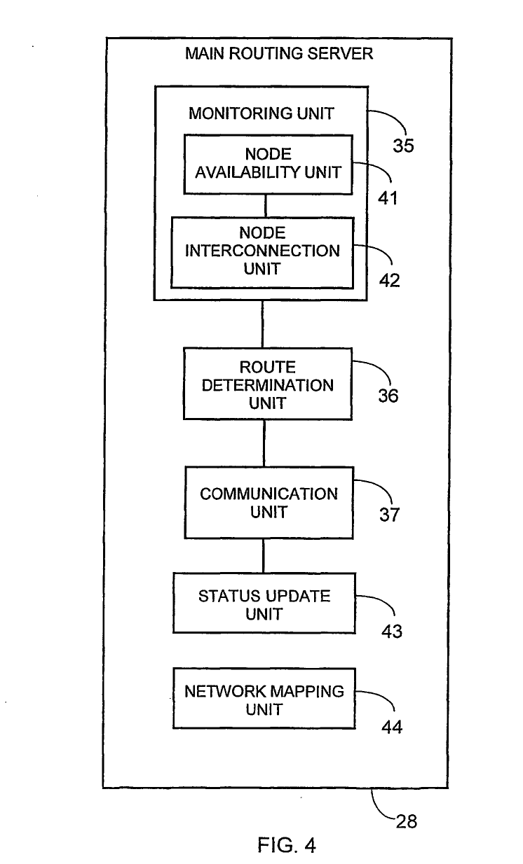

To this end, the main routing server 28 monitors the complete network 20 or, at the very least, a sufficient portion thereof to allow for improved routing between the source node 25 and the target node 25. FIG. 4 shows a detail of the main routing server 28, comprising a monitoring unit 35 for dynamically obtaining a respective 30 IP address of all available nodes in at least a portion of the network spanning the source node 24 and the target node 25 and their respective interconnections 23 if viable. The Internet traffic information may be obtained from multiple sources such as ISPs that monitor their own system, or from other enterprises that use monitoring tools. The main routing server 28 may include an embedded monitor of its own, where data is obtained by sending ping-type signals to most routers on the core of the Internet. An algorithm is used to determine the optimal subset of routers that give the maximum possible information. Such an algorithm may be based on the use of first derivatives correlations analysis, Bayesian statistics, maximal likelihood principle, and elements of information theory.

The traffic data is dynamically processed using Kalman Filters and Fourier analysis to filter out the information noise. Knowing the traffic information from the optimized set of routers, traffic flowing through other Internet nodes is estimated. To perform the evaluation, time-series analysis, forecasting methods, factor analysis, correlations analysis, regression analysis, cluster analysis and pattern recognition algorithms are used. The resulting functionality of the module allows gathering comprehensive Internet traffic information.

A route determination unit 36 is coupled to the monitoring unit 35 for dynamically determining an improved route between the source node 24 and a target route node connected to the target node 25 and identifying corresponding IP addresses of improved route nodes spanning the improved route. It is to be noted that in FIG. 2, the target route node is directly connected to the target node 25 and so is indistinguishable therefrom. However, the target route node may be connected indirectly to the target node 25 via another one of the route nodes.

The route determination unit 36 determines the optimal path or part of the path through the Internet, based on a customer's criteria. The optimization is based both on historical and the current values of the following parameters describing the Internet traffic:

path length

reliability

routing delay

bandwidth

jitter

load on the network components

The main routing server 28 identifies the bottlenecks on the paths from source node 24 to the target node 25 and overcomes or bypasses the bottlenecks, or adjusts its own behavior to the real traffic situation. A communication unit 37 is coupled to the route determination unit 36 for dynamically conveying the IP addresses to the source node 24 for allowing an agent in the source node to embed at least some of the IP addresses in the data so as to allow successive ones of the improved route nodes to which the data is routed to route the data to an adjacent one of the improved route nodes. In the case that strict source routing is used, this currently allows the data to be routed via no more than eight route nodes. Therefore, loose source routing is used to route the data via up to eight sub-networks as shown in dotted outline in FIG. 3 and explained above with reference thereto.

The monitoring unit 35 dynamically monitors at at least one location either the whole network or at least the portion spanning the source node 24 and the target node 25. The monitoring unit 35 includes a node availability unit 41 responsive to a node map of at least the specified portion of the network for determining whether each node in the node map is available. A node interconnection unit 42 is coupled to the node availability unit 41 for determining whether interconnections between adjacent available nodes are viable. The monitoring unit 35 also monitors other dynamic parameters such as delay time, packet loss, and transition time between adjacent nodes.

The main routing server 28 may further include a status update unit 43 coupled to the node availability unit 41 and to the node interconnection unit 42 for receiving external information indicative of changes to a status of nodes and interconnections in the network so as to allow such changes to be reflected in the improved route. Such external information is provided by the external information server 29 shown in FIG. 2 and typically being constituted by at least one Internet service provider. The external information server 29 may also provide external information indicative of constraints to be applied to the route along which the data is to be conveyed so as to allow such constraints to be reflected in the improved route. The main routing server 28 may further include a network-mapping unit 44 for mapping the network so as to obtain the node map. Alternatively, the network-mapping unit 44 may be an independent unit coupled to the main routing server 28.

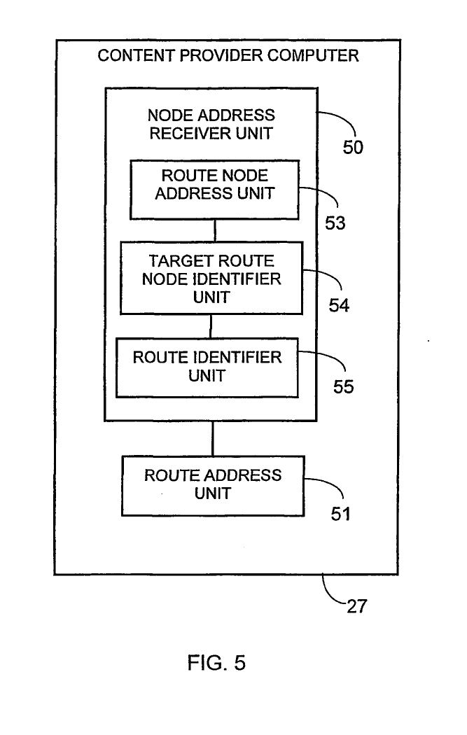

FIG. 5 is a block diagram showing a detail of a content provider computer 27, comprising a node address receiver unit 50 for receiving from the main routing server 28 corresponding IP addresses of improved route nodes spanning the improved route. A route address unit 51 is coupled to the node address receiver unit 50 for embedding at least some of the IP addresses in the data packet header so as to allow successive ones of the improved route nodes to which the data is routed to route the data to an adjacent one of the improved route nodes. Likewise, it sets a flag in the data packet header defining whether full source routing or loose source routing is to be used.

The node address receiver unit 50 includes a route node address unit 53 for receiving respective IP addresses of route nodes along respective improved routes between the source node and each route node connected thereto or a subset thereof. A tracing unit 54 is coupled to the route node address unit 53 for tracing a route to the target node in order to determine an IP address of a target route node connected thereto. In the Internet where thousands of target nodes may be connected to any given target route node, this is done typically by sending ping-type signals to the target route node, thus allowing its IP address to be determined. This allows an occasional unknown end-user to be targeted without the need to maintain a data-base containing the respective IP addresses of all target nodes. The tracing unit constitutes a target route node identifier unit for determining the IP address of the target route node. Alternatively, the target route node identifier unit may be constituted by a lookup table that is compiled in advance specifying, for each target node, the IP address of the improved route node that is closest thereto. This avoids the need to trace the route from the target node (whose IP address is known) to the closest target route node (whose IP address is unknown) and ensures that the target route node is recognized.

On the other hand, for an intranet, such as a Virtal Private Network or an ASP, where all target nodes are determinate and their respective IP addresses are known, this is not necessary. Aroute identifier unit 55 is coupled to the tracing unit 54 for identifying the respective improved route between the source node and the target route node. The modified data packet is then sent to the target node 25 using the standard software of the operation system.

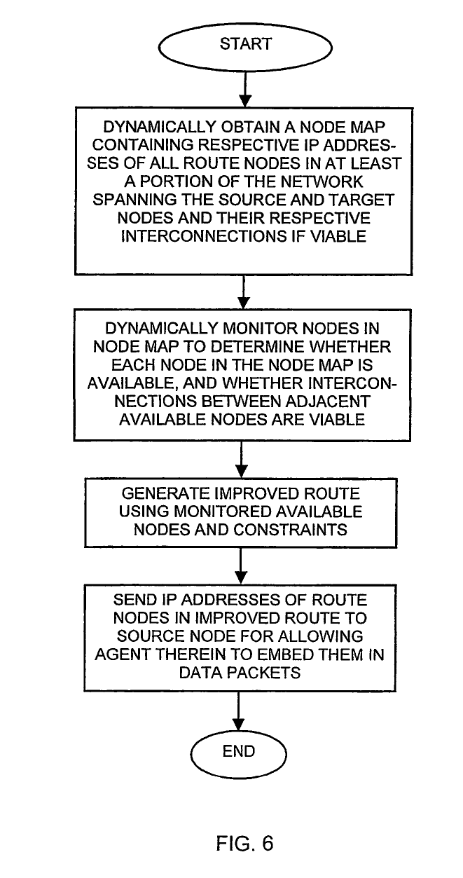

FIG. 6 is a flow diagram showing the principal operations carried out by the main routing server 28. The main routing server 28 dynamically obtains a node map containing respective IP addresses of all available nodes in the network or at least in the portion spanning the source node 24 and the target route node and their respective interconnections 23 if viable. This requires dynamically monitoring at at least one location at least the portion of the network spanning the source node and the target node. This may be done directly by the main routing server 28 or may be fed thereto by an external unit. Upon obtaining the node map data, the main routing server 28 determines whether each node in the node map is available, and whether interconnections between adjacent available nodes are viable. The server 28 obtains information on real-time status including latency at node, packet loss and path time. This information can be obtained by a monitoring unit embedded in the server 28 or from an external source. The server 28 may also receive external information indicative of changes to a status of nodes and interconnections in the network so as to allow such changes to be reflected in the improved route. The external information may be provided to the main routing server 28 by at least one Internet service provider, which may also provide external information indicative of constraints to be applied to the route along which the data is to be conveyed so as to allow such constraints to be reflected in the improved route.

To generate the improved route, the dynamic parameters monitored by the monitoring unit 35 must be considered in addition to the availability of the node. For example if the goal is to minimize the path time, then the optimization should know for each available node what is the latency at that node and also the path time from that node to the next adjacent node. The main routing server 28 uses this information to determine dynamically an improved route between the source node and a target route node connected to the target node and identifies corresponding IP addresses of improved route nodes spanning the improved route. Thereafter, it dynamically conveys the IP addresses to the source node 24 for allowing the source node to embed at least some of the IP addresses in the data so as to allow successive ones of the improved route nodes to which the data is routed to route the data to an adjacent one of the improved route nodes.

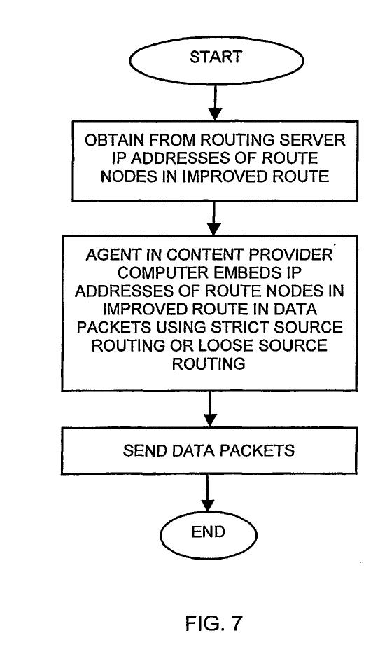

FIG. 7 is a flow diagram showing the principal operations carried out by a software agent in the content provider computer 26. The content provider computer 26 receives from the main routing server 28 corresponding IP addresses of improved route nodes spanning the improved route, and embeds at least some of the IP addresses in the data packet header so as to allow successive ones of the improved route nodes to which the data is routed to route the data to an adjacent one of the improved route nodes. The data packet is then sent to the target node 25 using the standard software of the operation system.

In use, the source node is typically a web server that is operated by a content provider and contains web pages that are downloaded by a client machine connected to the web server via the Internet The invention allows the web server to send a requested web page to the client via the optimal route, providing that the web server contains the necessary agent as described. To this end, the agent may be supplied as a software program stored on suitable computer readable medium that may be purchased by the content provider for loading on the web server or on a firewall coupled thereto. More generally, the content provider registers with the routing server in a one-time registration process during which the agent is uploaded by the routing server to the content provider's web server. In any event, it will be understood that the agent is remote from the routing server and must be loaded on each content provider's web server. This is distinct from hitherto-proposed systems where the complete optimization is both determined and implemented in a single location.

According to a business model, this may require the content provider to subscribe to the optimization service provided by the routing server and may levy a registration fee against the content provider in favor of a business enterprise operating the routing server. Likewise, the business enterprise may levy periodic subscription fees against each registered content provider. In any event, content providers who are not registered subscribers will not be licensed to receive the agent; or the agent resident on the content provider's web server can be disabled. In such case, the content provider's web server will be prevented from embedding the optimal route IP addresses in the data and so will be unable to benefit from the optimized route information received from the routing server.

It will be appreciated that modifications may be made to the invention without departing from the scope thereof as defined in the appended claims. Thus, for example, although typically mapping and monitoring are two separate and disconnected operations, at least theoretically it is possible to combine these functions so as to produce dynamic map data that at its inception already reflects the availability of nodes and their respective interconnections as well as any external constraints, as explained above. However, it will be appreciated that mapping the Internet is a time-consuming process owing to the sheer extent of the Internet and the vast and ever-increasing number of nodes therein. On the other hand, there is no need to map the Internet at the same frequency that the map data is monitored, since all that is really necessary in practice is the map data reasonably accurately reflect the network topology. In fact, at the instant of mapping any given node, the act of mapping the node provides some of the dynamic properties of the network that are usually determined by monitoring the network, since if a mapped node is unavailable for any reason, then it will not be included in the map data and so will not be available for routing data. Functionally, this is exactly what happens when a pre-prepared map is monitored and a node is found to be instantaneously unavailable.

It is also possible to distribute the act of mapping the network among a large number of map servers strategically placed at different points along the Internet. In this case, since multiple processors in parallel generate the map data, the mapping process may be accelerated. By such means, it could, at least theoretically, be accelerated to such an extent that it becomes feasible to combine the mapping and monitoring processes. However, where the resources available for generating the map data are limited, the mapping process is too time-consuming to allow the map data to be used as a reliable guide to the network topology. In any case, it will be appreciated that the monitoring process provides more comprehensive information about the network than merely the node availability and interconnectivity. It is therefore convenient to relate to the mapping and monitoring processes as two disassociated processes.

It will also be understood that the system and each component thereof according to the invention may be a suitably programmed computer or a customized chip or other hardware device adapted to carry out the method of the invention. Likewise, the invention contemplates a computer program being readable by a computer for executing the method of the invention. The invention further contemplates a machine-readable memory tangibly embodying a program of instructions executable by the machine for executing the method of the invention.

In the method claims that follow, alphabetic characters used to designate claim operations are provided for convenience only and do not imply any particular order of performing the operations.

1. A method for conveying data along an improved route from a source node (24) to a target node (25) between which data is sent using an IP protocol in a data communications network (20) having a plurality of interconnected nodes (22) defining a plurality of possible routes (23) between the source node and the target node, said method comprising:
(a) obtaining corresponding IP addresses of improved route nodes spanning said improved route, and
(b) embedding at least some of said IP addresses in said data so as to allow successive ones of said improved route nodes whose IP addresses are embedded in the data and which receive the data to route the data to an adjacent one of the improved route nodes.

2. The method according to claim 1, further comprising:
(c) conveying the IP addresses to the source node for allowing the source node to embed at least some of said IP addresses in said data.

3. The method according to claim 1 or 2, wherein (a) includes dynamically monitoring at at least one location at least a portion of the network.

4. The method according to claim 3, wherein the operation of dynamically monitoring includes:
i) determining whether each node in a node map of at least said portion of the network is available,
ii) determining whether interconnections between adjacent available nodes are viable, and
iii) obtaining information indicative of changes to a status of nodes and interconnections in the network so as to allow said changes to be reflected in the improved route.

5. The method according to claim 4, wherein obtaining information indicative of changes to a status of nodes and interconnections in the network includes sending a probe signal through the network so as to provide information relating to nodes probed thereby.

6. The method according to claim 4 or 5, wherein said information is received from at least one Internet service provider.

7. The method according to claim 3, further including:
(d) receiving from at least one Internet service provider external information indicative of constraints to be applied to the route along which the data is to be conveyed so as to allow said constraints to be reflected in the improved route.

8. The method according to any one of claims 1 to 7, wherein prior to operation (a) there is included the operation of mapping the network so as to obtain a node map of at least said portion of the network including all nodes and their respective interconnections therein.

9. The method according to any one of claims 1 to 8, further including:
(e) obtaining information indicative of changes to the network so as to allow said changes to be reflected in said node map.

10. The method according to claim 9, wherein said information is received from at least one Internet service provider.

11. The method according to any one of claims 1 to 10, wherein the corresponding IP addresses of improved route nodes spanning said improved route are received from a routing server (28) coupled to the source node.

12. The method according to any one of claims 1 to 10, wherein the corresponding IP addresses of improved route nodes spanning said improved route are identified from an improved route fed to the source node.

13. The method according to claim 11, wherein the data communications network is a Virtual Private Network and the routing server is a logical device coupled to the source node.

14. The method according to claim 17, wherein the source node receives from the target node a request that includes the corresponding IP addresses of improved route nodes spanning said improved route.

15. The method according to claim 14, wherein the target node receives the corresponding IP addresses of improved route nodes spanning said improved route from a routing server.

16. The method according to claim 11, wherein the target route node is connected to the target node and (a) includes:
i) receiving respective IP addresses of route nodes along respective improved routes between the source node and each route node connected thereto or a subset thereof, and
ii) identifying the respective improved route between the source node and the target route node.

17. The method according to any one of claims 1 to 16, wherein embedding at least some of said IP addresses in said data is achieved using source routing or loose source routing.

18. A routing server (28) for improving a route between a source node (24) and a target node (25) between which data is sent using an IP protocol in a data communications network (20) having a plurality of interconnected nodes (22) defining a plurality of possible routes (23) between the source node and the target node, said routing server comprising:
a monitoring unit (35) for dynamically obtaining a respective IP address and status of all available nodes in at least a portion of the network spanning the source node and the target node and their respective interconnections if viable,
a route determination unit (36) coupled to the monitoring unit for dynamically determining an improved route between the source node and the target node and identifying corresponding IP addresses of improved route nodes spanning said improved route, and
a communication unit (37) coupled to the route determination unit for dynamically conveying the IP addresses to the source node for allowing the source node to embed at least some of said IP addresses in said data so as to allow successive ones of said improved route nodes to which the data is routed to route the data to an adjacent one of the improved route nodes thus allowing the improved route nodes to be determined remote from the source node.

19. The routing server according to claim 18, wherein the monitoring unit dynamically monitors at at least one location at least said portion of the network spanning the source node and the target node.

20. The routing server according to claim 18, wherein the monitoring unit (35) includes:
a node availability unit (41) responsive to a node map of at least said portion of the network for determining whether each node in the node map is available, and
a node interconnection unit (42) coupled to the node availability unit for determining whether interconnections between adjacent available nodes are viable.

21. The routing server according to any one of claims 18 to 20, further including at least one Internet service provider for providing information indicative of constraints to be applied to the route along which the data is to be conveyed so as to allow said constraints to be reflected in the improved route.

22. The routing server according to any one of claims 18 to 21, further including a network mapping unit (44) for mapping the network so as to obtain said node map of at least said portion of the network including all nodes and their respective interconnections therein.

23. The routing server according to any one of claims 18 to 22, further including:
a status update unit (43) coupled to the node availability unit and to the node interconnection unit for receiving information indicative of changes to a status of nodes and interconnections in the network so as to allow said changes to be reflected in the improved route.

24. The routing server according to claim 23, including at least one Internet service provider for providing said information.

25. The routing server according to any one of claims 18 to 24, wherein said IP addresses are embedded in said data using source routing or loose source routing.

26. A computer (27) for fetching data along an improved route from a source node (24) using an IP protocol in a data communications network (20) having a plurality of interconnected nodes (22) defining a plurality of possible routes (23) between the source node and the computer, said computer comprising:
a node address receiver unit (50) for receiving from a routing server (28) coupled to the source node (24) corresponding IP addresses of improved route nodes spanning said improved route, and
a route address unit (50) coupled to the node address receiver unit for embedding at least some of said IP addresses in said data so as to allow successive ones of said improved route nodes to which the data is routed to route the data to an adjacent one of the improved route nodes.

27. The computer according to claim 26, wherein said IP addresses are embedded in said data using source routing and loose source routing.

28. The computer according to claim 26 or 27, wherein the target route node is directly connected to the target node via one of the route nodes in said subset and the node address receiver unit includes:
a route node address unit (53) for receiving respective IP addresses of route nodes along respective improved routes between the source node and each route node connected thereto or a subset thereof, and
a route identifier unit (55) coupled to the route node address unit (53) for identifying the respective improved route between the source node and the target route node.

29. The computer according to claim 26, wherein the target route node is indirectly connected to the target node via one of the route nodes in said subset and the node address receiver unit includes:
a route node address unit (53) for receiving respective IP addresses of route nodes along respective improved routes between the source node and each route node connected thereto or a subset thereof,
a target route node identifier unit (54) coupled to the route node address unit for determining the IP address of the improved route node that is closest to the target node, and
a route identifier unit (55) coupled to the target route node identifier unit for identifying the respective improved route between the source node and the target route node.

30. A computer program comprising computer program code means for performing all the steps of any of claims 1 to 17 when said program is run on a computer.

31. A computer program as claimed in claim 30 embodied on a computer readable medium.
